(19) United States
(12) Patent Application Publication
(10) Pub. No.: US 2009/0299509 A1
(43) Pub. Date: Dec. 3, 2009

(54) Method for Simulating a Controller and/or Machine Response of a Machine Tool or of a Production Machine

(76) Inventors: Matthias Diezel, Nurnberg (DE); Marc Holz, Erlangen (DE); Thomas Menzel, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/992,528

(22) PCT Filed: Sep. 20, 2006
(86) PCT No.: PCT/EP2006/066528

§ 371 Date: Jul. 10, 2009

(30) Foreign Application Priority Data
Sep. 30, 2005 (DE) 10 2005 047 543.4

(51) Int. Cl. G05B 19/4069; G06G 7/66

(52) U.S. Cl. 700/97; 703/7

(57) ABSTRACT

There is described a method and device for simulating a control and/or machine behavior of machine tools or production machines, in which data concerning the machine tools or production machines are transmitted to a simulation device by mans of an intranet and/or by means of an internet. The data can be automatically transmitted to the simulation device, whereby particularly after a change in an item of data from the quantity of data, this item of data is transmitted to the simulation device.

### CROSS REFERENCE TO RELATED APPLICATIONS

This application is the US National Stage of International Application No. PCT/EP2006/066528, filed Sep. 20, 2006 and claims the benefit thereof. The International Application claims the benefits of German application No. 10 2005 047 543.4 DE filed Sep. 30, 2005, both of the applications are incorporated by reference herein in their entirety.

### FIELD OF INVENTION

The invention relates to a method and an apparatus of a controller and/or machine response of a machine tool or of a production machine.

### BACKGROUND OF INVENTION

As requirements relating to quality and economic viability become more stringent in the field of application of machine tools and production machines, with machine tools and production machines also encompassing robots, the complexity of such machines increases constantly. Novel machine kinematics and complex mechatronic functions require increasingly high performance functions for mechanical systems, drives and controllers. However these are not always easy to develop and design. Therefore manufacturers increasingly have an urgent need to evaluate and optimize the productivity of a machine, the exact response of controller signals, sensor signals and individual axial movements previously used for collision control with the aid of simulation during product development. Simulation here can reproduce the mechanical response of the machine, the response of the drives and also the function of the controller. Only then is it possible to model the temporal response of the mechanical system, the drives and the numerical controller precisely, for example to simulate NC machining or tool changes.

Models with varying degrees of detailing are currently used to model the mechanical response of machine tools, for example:

geometric kinematics models (these only take into account geometry, not mass and elasticity of machine elements),

substitute models for process simulation, e.g. Petri networks, networked function modules,

models for rigid multi-body systems (in particular in conjunction with flexible connecting elements),

multi-mass models (these also take into account mass and elasticity in the drive train),

flexible multi-body systems and

FE models (finite elements allow total discretization of the mechanical system).

The controller can also be integrated into the model by means of software simulation or the original controller hardware including original software is used. A numerical controller essentially consists for example of a so-called Numerical Control Kernel (NCK), which controls NC-controlled, regulated axes in the composite interpolation system (e.g. covering a circuit) and a Programmable Logic Control (PLC) which generally controls unregulated axes, e.g. for a tool changer. In some applications however the PLC also controls regulated axes. The controller thus likewise integrates regulated axes in the composite interpolation system (e.g. curve tracing) and auxiliary/feed axes, which are traversed in a regulated or unregulated manner.

If for example a machine tool or a production machine (e.g. a plastic injection molding machine, a printing machine, an automatic packaging machine, etc.) is supplied and installed by the manufacturer, it is initially in a known and defined state. During production the state and configuration data of the machine change due to new production processes, maintenance, repair, wear, etc. Knowledge of the precise state of the machine is frequently necessary, for example:

to restart a system,

to schedule the next maintenance operation,

to carry out production planning,

to allow a simulation of the current machine model and/or

to optimize a new parts program based on the current machine state.

Continuous acquisition and documentation of the necessary state parameters of the machine tool is complex and therefore does not happen.

Geometric, technological, economic and qualitative parameters for example are specified for the construction of a workpiece on a machine tool. These parameters restrict the selection of the manufacturing machine tool accordingly. Therefore in order to be able to manufacture the workpiece optimally on a machine tool, it is necessary to have precise knowledge of the capacity and technical possibilities of said machine. The scope of the technological parameters complicates on the one hand the selection process for the most suitable machine tool and on the other hand the NC program design by the NC programmer. Both tasks require very broad technical experience and precise knowledge of the machine parameters and machine technology. The most suitable machine tool results from maximum compliance with different specified criteria for manufacture (e.g. relating to manufacturing costs, surface quality, output, size, technology, etc.). The optimum NC program results for example from a combination of best workpiece quality and shortest production time. The decision regarding the machine on which a workpiece should be manufactured has hitherto been made by operators based on their experience and their knowledge of the machine.

The operator can also use a simulation to decide which machine tool to select. If the machining of a workpiece is simulated, a separate simulation run has to be carried out for each machine. This procedure can of course also be used for production machines. To simulate a machine tool it is necessary to know the NC parts program. Until now these programs were created either with the aid of a CAM system at the preparatory stage or on site directly at the machine tool.

A more reliable but also more cost-intensive approach both to machine tool selection and NC program optimization to date has been to manufacture a sample part on the respective machines. This workpiece is then assessed visually. Precise measurement of the sample parts is very cost-intensive and time-consuming. If a manufactured sample part meets the required criteria best, the machine tool used to manufacture this sample part is selected for the manufacturing task. The same also applies to the design of NC programs. If the quality of the sample part is optimal, NC programming can be terminated at the parts program. The presence of a programmer or production planner on site at the machine is necessary for both applications.

### SUMMARY OF INVENTION

An object of the invention is both to allow improved simulation of a controller and/or machine response of a machine tool or of a production machine and also to utilize the simulation results better.

The object is achieved with a method with the features as claimed in an independent claim and an apparatus with the features as claimed in a further independent claim. Subclaims relate to advantageous developments of the invention.

With an inventive method for simulating a controller and/or machine response of machine tools or of production machines, data relating to the machine tool or production machine is transmitted from these to a simulation facility by means of an intranet and/or internet. The data here relates in particular to state data and/or parameter data, which can be modified for example during commissioning and/or optimization of the machine. It includes for example gain parameters, idle times, delay elements, parameters for integration elements of a regulator, etc. Data can also relate for example to information about a performance, control quality, a configuration stage of the machine, etc. This data is data relating to the production machine or machine tool, with this data also including data from facilities for regulating and/or controlling the production machine or machine tool. The data is in particular parameter data and/or configuration data and/or hardware data and/or program data, e.g. a parts program, and/or performance data.

The data from the machine tools or production machines is transmitted from these by way of a network to the simulation facility. This means for example that a regulation facility and/or a control facility, provided to regulate and/or control the machine tools or production machines, transmits the data to a server. The server is connected by way of the internet to a further server, with the further server receiving the data. The further server is then itself the simulation facility or it transmits the data to the simulation facility connected for data purposes to the further server.

If the machine tools or production machines have a regulation and/or control facility, in an advantageous embodiment this regulation and/or control facility can be simulated or emulated on a separate computer or the downstream computer. The computer is the simulation facility, with the computer and machine being connected to each other for data purposes in a local network with worldwide distribution. The computer for example accepts a connection to the real machine to upload the current configuration of the machine (machine data). Downloads can also be performed.

If the simulation facility does not use the original regulation and/or control facility, the inventive apparatus can be set up using standard hardware, despite the often different, machine-related controller hardware of the machine. This method advantageously uses a virtual NCK on the simulation facility.

In a further embodiment the simulation is carried out on the simulation facility in real time. This allows a user to have a temporally correct representation of a manufacturing process in a simple manner.

According to a further embodiment of the invention configuration data and/or state data of the production machine or of the machine tool is transmitted to a simulation model synchronized with the production machine or machine tool. The simulation model is calculated on the simulation facility. Synchronization here relates in particular to an identical database used and/or a temporally synchronous simulation.

Until now planning and monitoring systems for a production and/or manufacturing plant were based on states of the production and/or manufacturing facilities other than those that actually occurred in reality, since changes were not taken into account. This affected for example the configuration of the tools, the wear to machine elements, etc. As a result, until now it was frequently only established immediately before or even during manufacture that operating means or tools were unsuitable or missing, so that manufacturing orders had to be rescheduled at high cost. The inventive transmission of data to the simulation facility improves the simulation and therefore also the planning methods associated therewith. The transmission of wear data to the simulation facility in particular contributes to this.

The transmission of data to the simulation facility is initiated for example by an operator of the machine tool or production machine or is automatic in a further embodiment of the invention. Automatic transmission of the data to the simulation facility takes place at least for example after modification of a data item from the set of data, with this data item at least being transmitted to the simulation facility. It is possible therefore either to transmit all the data or advantageously only the data that has been modified since the last data transmission is transmitted.

The inventive method can also be developed in that:

in the case of machine tools the sample workpiece is manufactured on one or more machine tools in a simulative manner by means of the simulation facility using data-based models of one or different machine tools and a data-based model of the workpiece and

in the case of production machines the sample production item is manufactured on one or more production machines in a simulative manner by means of the simulation facility using data-based models of one or different production machines and the data-based model of a production item.

Since this method uses a system which has a computer as the simulation facility for example, with the computer being connected to the facility for controlling and/or regulating the machine tool and/or production machine by way of the intranet and/or internet for the purposes of exchanging data, the simulation facility can be used for a number of machines at different locations worldwide. This improves utilization of the capacity of the simulation facility and allows a global comparison of machines. For this it is necessary for the simulation facility or a facility connected thereto, which is therefore part of the simulation facility, to store data from a number of machine tools or production machines, with simulation results of at least two machine tools or production machines in particular being compared automatically and/or being able to be compared by way of a human-machine interface (HMI).

A simulation system for the machine tool is for example present on the computer for simulation purposes, said simulation system being made up of controller models (for controller emulation), kinematics and the machining process and being able to be expanded using further models. It can be determined from an automated comparison of simulation results which production machine or machine tool best meets the requirements relating to quality, quantity and/or economic viability individually or in combination. Thus a method and/or system is proposed, with which simulation results are further processed using the simulation facility and/or an additional facility in such a manner that a machine tool or production machine is proposed for real use after the simulation of at least two machine tools or production machines.

In a further embodiment of the method data relating to the machine tools or production machines for the simulation is modified on the simulation facility. This data relates for example to parameters of a regulator or even data which can be used to simulate possible configuration stages of the machine. After the modification of at least one data item or even a number of data items a simulation is carried out on the simulation facility for example using the amended data. After modification modified data can also be transmitted to the machine tool or production machine without further simulation. It is advantageous if simulation results are stored, on which different data sets are based, so that these can be compared. After the comparison and in particular after a qualitative automatic evaluation of the simulation results, the qualitatively better data set or machine is selected, whereupon at least the data of the selected data set that is different from the data stored by the machine tools or production machines is transmitted to these. It is also possible to transmit the entire data set. The transmitted data is used in particular for reparameterization of a controller or regulator.

A consistent simulation model of a machine tool or production machine can be achieved with the inventive method. The state of:

emulation of the controller and/or regulator,

the kinematics simulation,

the drive technology simulation and/or machining process simulation

is advantageously in the same state as the real machine tool at all times. The time here relates at least to the time of the simulation.

The simulation model, which is consistent at all times with the real machine tool or production machine, allows the investigation of the impact of changes to a manufacturing system as a whole. The data determined from the model can be included in short and long-term manufacturing planning and can be used to optimize the manufacturing process at the machine tool or the overall manufacturing process in a manufacturing system.

Simulation results and/or stored data from the machine tool or production machine are used in a further variant for starting up and/or closing down a production machine or machine tool in a protected manner.

Simulation results and/or stored data from the machine tool or production machine can also be used in a CAM system for manufacturing planning. This relates in particular to data relating to one or more tools.

The invention also has the advantage that the continuous documentation of the machine state that is now possible allows more precise planning of maintenance work. Such planning can be automated, with planning being optimized for example with the aid of a trend analysis of the existing data.

The invention also relates to an apparatus for carrying out one or more of the method steps described above. For this purpose the apparatus has a simulation facility, which is provided both to carry out a simulation step and also in particular to carry out a comparison step for simulation results.

By connecting the simulation facility to the machine by way of a network, such as the internet for example, it is possible to achieve at least one of the following points:

use of the current configuration of the machine for starting up a controller emulation on the computer;

use of the controller emulation to carry out the simulation of a machining task using the configuration data of the machine;

linking the controller emulation to models for simulating the drive, mechanical system (e.g. kinematics), and/or the machining process (e.g. material removal);

evaluating the simulation results in the context of machine selection, e.g. in the case of machine tools, determining the machining time, surface quality, compliance of all measurement points, machining costs and/or machining quality, with the aid of the simulation of the machining task on the simulation facility;

aligning the simulation results with the model data of a workpiece to be manufactured in the context of an NC program optimization. In addition to a precise 3D model, this contains all the relevant manufacturing data available for the alignment;

automated multiple repetition (e.g. by means of a batch operation) of the simulation for different configurations of one or more machines;

access to functions and data of the simulation facility by way of the intranet and/or internet using a web portal or a client application from further simulation facilities.

### BRIEF DESCRIPTION OF THE DRAWINGS

Exemplary embodiments and/or further embodiments of the invention are described in more detail below and illustrated in the drawing, in which:

FIG. 1 shows a first illustration of the invention and

FIG. 2 shows a further illustration of the invention.

### DETAILED DESCRIPTION OF INVENTION

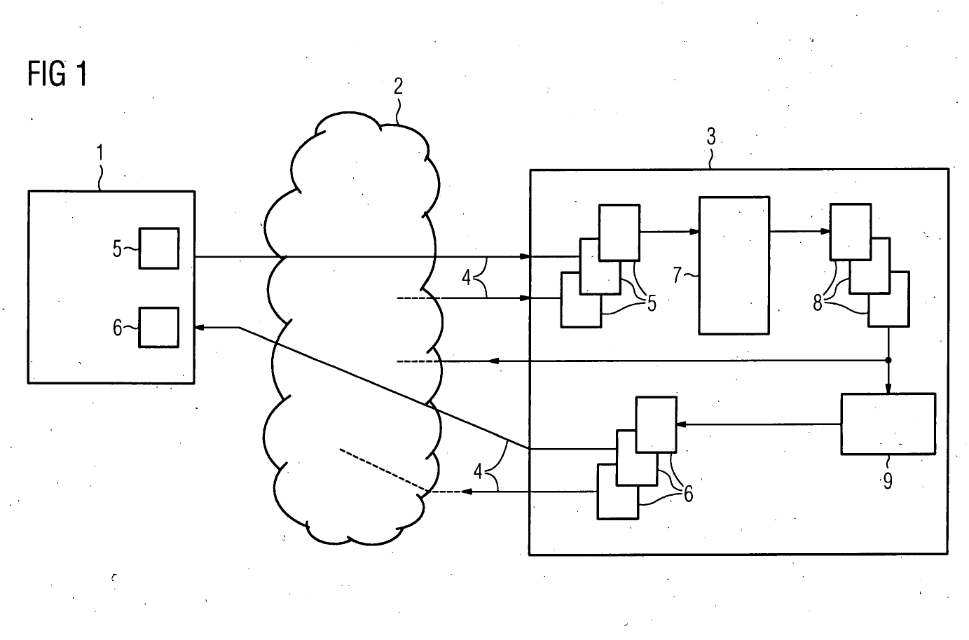

The illustration according to FIG. 1 shows a symbolic diagram of a machine 1. The machine 1 is a machine tool for example, which has a CNC (Computer Numerical Control), or a production machine. Data 5 is stored in the machine 1. This data 5 can be transmitted by way of an internet 2 by means of a data transfer 4 to a simulation facility 3, with the data relating for example to configuration data, wear data and/or traces. The simulation facility 3 is for example also a system for monitoring manufacturing and/or production planning. The simulation facility 3 is provided in particular as a controller emulation and/or as a facility for executing other simulation models (e.g. simulation with a CNC emulation), with persistent storage of model process data being carried out for example in the simulation facility 3.

A number of different data items 5 from one or more machines (not shown) are stored on the simulation facility 3. The data 5 is used for a simulation 7 on the simulation facility 3, with simulation results 8 being made available after the simulation 7. The simulation results 8 show how the machine response of a machine changes with different data and how a number of machines differ from each other in their response. The simulation results 8 can also be used to carry out a setpoint/actual comparison between the simulation and reality.

The simulation results 8 are compared in a comparison step 9 and/or transmitted by way of the internet 2. The comparison gives rise to comparison results in such a manner that specific data items 6 can be preferred. The preferred data items 6 are then transmitted back to the machine 1. These data items 6 relate in particular to correction data for implementing measures to improve the machine response. The corrections are made automatically for example after the comparison of the simulation results, with a new simulation with the corrected data being possible. The machine 1 is operated with the preferred data items 6 by the end of the method. The simulation results 8 also allow a trend analysis for example, it being possible also to derive measures relating to a data modification herefrom.

An inventive system allows an automatic adaptation of machine tool simulation models. The system has the simulation facility 3, which is a computer for example, which is connected to controllers of machine tools by way of the intranet or internet for the purpose of exchanging information. A simulation system for the machine tool is present on the computer. Data 5 from the real machine tool 1 is transmitted to the models of the simulation system (e.g. for controller, drive technology, workpiece, tool and machine tool) and documented there. The system can be expanded according to requirements with further state data and models of the machine tool.

The system and a method based thereon have at least one of the following features in particular:

an accepted connection from the simulation facility 3 to a real machine 1 for transmission of the current configuration (machine data) and state data;

current configuration data and state data is used to keep the simulation model consistent with reality;

the configuration data is the machine data of a numerical controller (including drive and tool data);

the state data is process data (e.g. axial positions) and machine or tool characteristics influenced by wear, working life or service life;

the simulation model includes an emulation of the controller, a simulation of the kinematics, the drive technology and/or the machining process;

an interface with the simulation facility allows access to data from the simulation facility 3 by way of the intranet or internet 2 from further simulation facilities (not shown).

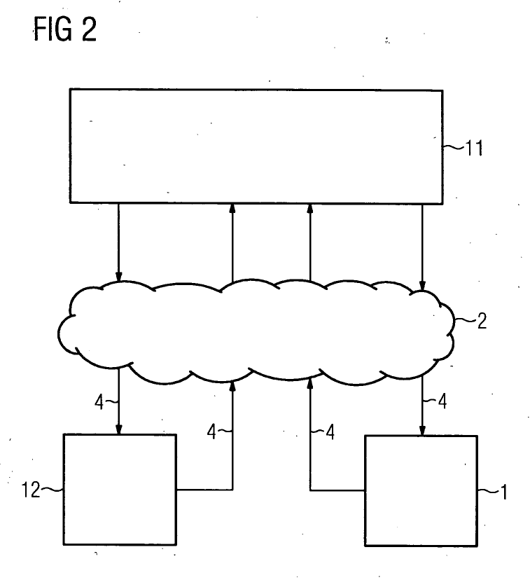

The diagram according to FIG. 2 shows a server 11. A programming station 12 is connected to the server for data purposes. The server 11 is designed as a simulation facility, with simulation results being transmitted to the programming station 12 for example by way of the internet 2. In one embodiment (not shown) the programming station 12 is integrated in the machine 1. This integration is either a local integration or a functional integration. The programming station 12 should be considered part of the machine 1 even in the case of a functional integration. Parts programs, workpiece models (CAD, 3D, etc.) production requirements and/or quality criteria can be transmitted from the programming station 12 to the simulation facility 11 by means of the data transfer 4 by way of the internet 2. Machine data from the machine 1 can be transmitted to the simulation facility 11. From the simulation facility 11 a new parts program can be transmitted to the machine 1 by way of the internet 1.

Use of an inventive system means that the machine selection is no longer made just on the basis of poorly defined empirical values but with the support of a transparent evaluation. This avoids expensive estimation errors. This relates both to the use of existing machines and the purchase of new machines.

The system and a method based thereon in particular has at least one of the following features or a corresponding advantage:

the system offers a workpiece producer the possibility of including in the comparison machines which are not (yet) physically available, as machine producers can offer their machines globally using this system;

the simulation can on the one hand be operated by the party wishing to manufacture the workpiece so that the workpiece model does not have to be disclosed and know-how protection is maintained;

the simulation can be outsourced to a reliable entity, so that know-how protection can be ensured both for the machine producer and for the workpiece manufacturer;

the system can serve a manufacturing planner beforehand when selecting a machine or can for example assist the NC programmer when generating a sub-program for a current machine configuration;

the NC programmer no longer has to be on site to create and test the NC program but can operate anywhere by way of the software system;

the NC programmer is able to simulate his/her NC programs locally on his/her PC or to outsource them as a simulation order to a reliable entity (computer);

the NC programmer can use this system to design programs both for machines in his/her own company and for external machines connected to the computer. This makes global commissions a possibility.

the NC programmer can use this system to tailor parts programs to the current machine configuration and thus ensure functionality.

1.-7. (canceled)

8. A method for simulating a controller of a machine or for simulating a response of a machine, wherein the machine is a machine tool or a production machine, comprising:
transmitting data related to the machine from the machine to a simulation facility via an intranet and/or via an internet.

9. The method as claimed in claim 8, wherein one of the data is transmitted automatically to the simulation facility after a modification of the data.

10. The method as claimed in claim 9, wherein one of the data is selected from the group consisting of parameter data, configuration data, hardware data, program data, performance data, and a combination thereof.

11. The method as claimed in claim 8, wherein the simulation facility stores data from a plurality of machines, wherein particular simulation results from at least two machines are compared automatically.

12. The method as claimed in claim 8, wherein the simulation facility or an additional facility further processes simulation results such that a machine is proposed for use after the simulation of at least two machines.

13. The method as claimed in claim 11, wherein data relating to the machine is modified for the simulation on the simulation facility, whereupon
a simulation is carried out with the modified data, and
at least the modified data is transmitted to the machine,
wherein simulation results of different data sets are stored and compared, whereupon a data set is selected and at least the data of the selected data set that is different from the data stored by the machine is transmitted to the machine.

14. The method as claimed in claim 11, wherein one of the data transmitted to the simulation facility is related to a control quality.

15. The method as claimed in claim 11, wherein one of the data transmitted to the simulation facility is related to a wear to a machine element, wherein the simulation is based upon the wear of the machine element.

16. The method as claimed in claim 14, wherein the simulation in the simulation facility is based upon a virtual Numerical Control Kernel.

17. The method as claimed in claim 1, wherein the simulation is synchronous to the operation of the machine.

18. The method as claimed in claim 16, wherein the simulation is synchronous to the operation of the machine.

19. The method as claimed in claim 17, wherein state of
an emulation of the controller,
a kinematics simulation, and
a drive technology simulation
is in the same state as the real machine tool at all times of the simulation.

20. The method as claimed in claim 11, wherein the simulation facility transmits a parts program new for the machine to the machine via the internet.

21. The method as claimed in claim 16, wherein the simulation facility transmits a parts program new for the machine to the machine via the internet.
